(19) United States
(12) Patent Application Publication
(10) Pub. No.: US 2005/0022600 A1
(43) Pub. Date: Feb. 3, 2005

(54) Method and device to determine the natural frequencies of a bearing system having a shaft arranged on bearings

(75) Inventors: Eduard Hudec, Villingen-Schwenningen (DE); Guido Schmid, Triberg (DE); Karl Gerhard Weiss, Munich (DE); Susanne Weiss, Munich (DE); Annette Sader, Berlin (DE)

Correspondence Address: LAW OFFICE OF BARRY R LIPSITZ, 755 MAIN STREET, MONROE, CT, 06468, US

(73) Assignee: MINEBEA CO., LTD., Magano-ken (JP)

(21) Appl. No.: 10/884,366

(22) Filed: Jul. 2, 2004

(30) Foreign Application Priority Data
Jul. 15, 2003 (DE) 103 33 410.6

(51) Int. Cl. G01H 1/12; G01H 11/08; G01H 13/00; G01M 13/04

(52) U.S. Cl. 73/579; 73/593

(57) ABSTRACT

A method to determine the natural frequencies of a bearing system having a shaft arranged on bearings is disclosed in which the shaft is vibrationally excited from one end of the shaft and a measurement signal is picked up at the other end of the shaft using a vibration sensor.

The present disclosure relates to the subject matter disclosed in German application No. 103 33 410.6 of Jul. 15, 2003, which is incorporated herein by reference in its entirety and for all purposes.

### BACKGROUND OF THE INVENTION

The invention relates to a method and a device to determine the natural frequencies of a bearing system having a shaft arranged on bearings.

To ensure the flawless functioning of a system having a shaft, it is often necessary to determine the natural frequencies of the bearing system as a whole or as individual components and assemblies.

### SUMMARY OF THE INVENTION

In accordance with the invention, a method and a device to determine the natural frequencies of a bearing system are provided, enabling these natural frequencies to be measured with high precision and high reproducibility.

In accordance with the invention, the shaft is vibrationally excited from one end of the shaft and a measurement signal is picked up at the other end of the shaft using a vibration sensor.

The method according to the invention makes it possible to achieve defined coupling of a vibration excitation signal and defined decoupling of a measurement signal. The influence on the measurement due to different coupling and excitation is minimized so that high reproducibility can be achieved. At the same time, high measurement precision can also be achieved. The method according to the invention can be carried out non-destructively.

It is moreover ensured that the resonance characteristics of the bearing system is not changed due to the coupling of measurement sensors.

The bearing system can be a complete electric motor, for example, or only a part of the bearing system such as a rotor with its shaft. This means that the relevant assemblies of the bearing system can be tested or the complete system.

It is particularly advantageous if the shaft is excited via one (first) end face and the measurement signal is picked up at a (second) end face. This enables defined coupling and excitation as well as decoupling to be achieved. It is also possible to pick up the measurement signal, for example, at an outer bearing ring or a motor hub. Here, both the outer bearing ring and the motor hub are connected to the end of the shaft, the signal being indirectly picked up at the end face of the shaft via the bearing outer ring or the motor hub, but at any rate from the end of the shaft.

It is moreover particularly advantageous if the excitation signal and a resulting measurement signal are correlated. This makes it possible for high measurement precision to be achieved along with high reproducibility.

It is favorable if the transfer function with respect to the excitation signal and the measurement signal is determined. The measurement signal is determined by the excitation signal and the vibration characteristics of the shaft. If the excitation signal is known, determining the transfer function enables the vibration characteristics of the system that journals the shaft to be ascertained.

A harmonic analysis in particular is then performed to determine the transfer function. A Fourier analysis, and in particular, a fast Fourier analysis (FFT) is preferably performed. The convolution characteristic of the Fourier analysis makes it possible to determine the transfer function as a function of frequency.

It is particularly advantageous if the shaft is excited using a piezo vibrator. This makes it possible to excite the shaft to vibrate in a defined way. The piezo vibrator itself is electrically excited using a generator. The generator signal is a measurement for the excitation signal of the shaft. For the purpose of further analysis, to determine a transfer function for example, this generator excitation signal can be processed in a simple manner.

Using a piezo vibrator, defined vibrational excitation of the shaft can be achieved, allowing in turn high reproducibility of the measurement signals.

For the same reason, it is favorable if the measurement signal is picked up via a piezo sensor. The piezo sensor is vibrationally excited via the shaft and the electrical signal generated represents a measurement signal that can be easily analyzed using an analysis device. However, other types of vibration sensors can also be used, for example, accelerometers or laser vibrometers.

It has proven advantageous if a vibrational excitation signal that is coupled into the shaft is determined using another vibration sensor. This other vibration sensor can be a piezo sensor, a laser vibrometer or any other sensor suitable for measuring vibrations. This sensor directly measures the vibrational excitation signal which is used to vibrationally excite the shaft. In other words, it directly measures the excitation signal for the shaft. By analyzing this signal to correlate with the measurement signal of the vibration sensor at the other end of the shaft, a precise transfer function is obtained.

In accordance with the invention, a device to determine the natural frequencies of a bearing system having a shaft arranged on bearings is provided, comprising a vibrational excitation device to vibrationally excite the shaft via one end of the shaft and a vibration sensor to pick up a vibration measurement signal at the other end of the shaft.

This device has the same advantages as already outlined in relation to the method according to the invention.

Other beneficial embodiments have also been outlined in connection with the method according to the invention.

In particular, the shaft can be positioned between the vibrational excitation device and the vibration sensor in order to thus obtain a defined force transmission to vibrationally excite the shaft and a defined transmission of force from the shaft. If the shaft is positioned in the device with its axis aligned to the force of gravity, the bearing system can be fixed in a simple manner: the shaft is set on the vibrational excitation device with it being possible (but not necessary) to interpose a transmission element. The shaft is then held in this position by means of a weight element that acts on the vibration sensor, having a damping element between these two elements.

It is particularly favorable if the vibrational excitation device can be coupled to one end, and in particular to the end face, of the shaft and the vibration sensor coupled to the opposite end, and in particular end face, of the shaft. This makes it possible to obtain a defined vibration coupling into the shaft and a vibration decoupling from the shaft.

It is particularly favorable if a further vibration sensor is arranged between the vibrational excitation device and the shaft. This vibration sensor can then directly measure the excitation signal for the shaft. This excitation signal is supplied to the analysis device in order to ascertain the transfer function. An excitation signal directly measured in this way provides a better measurement for determining the transfer function than if a generator excitation signal is used since the vibrating system can behave differently from this generator excitation signal.

The following description of a preferred embodiment in conjunction with the drawings serves to explain the invention in more detail.

### BRIEF DESCRIPTION OF THE DRAWINGS

FIG. 1 a schematic view of an embodiment of the device according to the invention;

FIGS. 2 to 4 examples of a determined transfer function for a roller bearing system with different internal bias tensions.

### DETAILED DESCRIPTION OF THE INVENTION

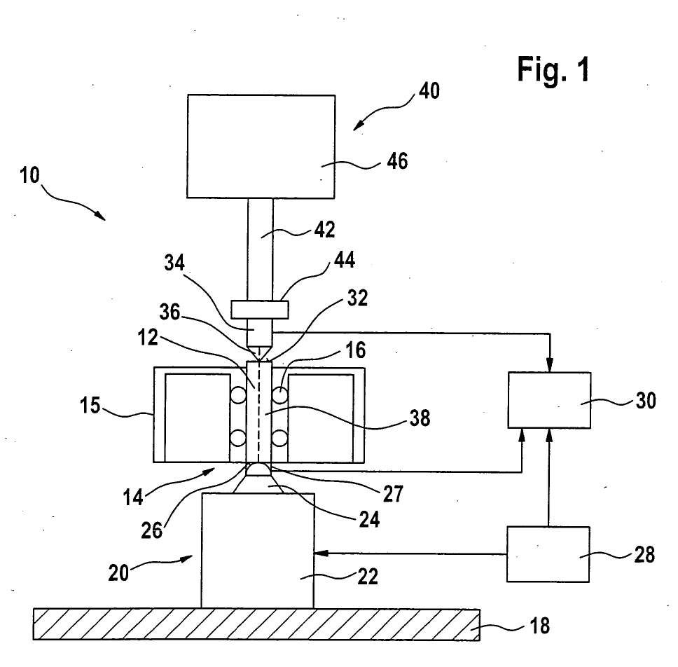

An embodiment of the device in accordance with the invention to determine the natural frequencies of a bearing system having a shaft arranged on bearings is schematically shown in FIG. 1 and indicated there in its entirety by 10. Using this device, the natural frequencies of the bearing system having a, e.g. journalled, shaft 12 can be determined. The bearing system can, for example, be an electric motor 15 or parts of such an electric motor. The shaft 12 is then the motor shaft accordingly.

In the example illustrated, the shaft 12 is supported in a bearing 14 such as a roller bearing. Ball elements 16 belonging to such a roller bearing are indicated in FIG. 1.

The device 10 has a base 18 allowing it to be set on a foundation so that the device 10 is subject to low vibration.

The device 10 according to the invention has a vibrational excitation device 20 which, for example, comprises a piezo vibrator 22. In the illustrated embodiment, the vibrational excitation is transferred to the shaft 12 by means of a conical transmission element 24. This transmission element 24 is coupled to an end face 26 of the shaft 12, a tip penetrating into a hollow at the shaft end 26.

It is possible for the end 26 of the shaft 12 to be directly coupled to the piezo vibrator 22, and particularly with a planar end 26, for the shaft 12 to stand on the piezo vibrator 22.

Provision can be made for a vibration sensor 27 to be arranged between the piezo vibrator 22 and the shaft 12 by means of which the excitation signal of the shaft 12 can be directly ascertained.

The piezo vibrator 22 is excited by means of a generator 28. The corresponding electrical excitation signal is thus delivered to the piezo vibrator 22 in order to generate time defined vibrations which in turn are transmitted to the shaft 12 via the end face 26.

The generator 28 also delivers its (electrical) excitation signal to an analysis device 30. If a vibration sensor 27 is positioned before the shaft 12, then this delivers its measurement signal to the analysis device 30 as an alternative or in addition.

A vibration sensor 34 is coupled to an end face 32 lying opposite the end face 26 of the shaft 12, the vibration sensor 34 picking up a vibration signal as a measurement signal at this end 32 of the shaft. This measurement signal is a function of the excitation signal and the vibration characteristics of the shaft 12.

The vibration sensor 34 can, for example, be an accelerometer or a piezo sensor, or instead a contactless sensor, such as a laser vibrometer, can be used. For sensors without contactless measurement, a conical transmission element 36 can be provided which is coupled to the end face 32 of the shaft 12. This transmission element 36 picks up vibrations from the shaft 12 and leads them to the vibration sensor 34. The vibration sensor 34 generates an electrical signal as a measurement signal or a measurement signal that can be converted into an electrical signal which is passed on to the analysis device 30. The transfer function is ascertained in the analysis device 30 by means of a harmonic analysis, in particular, by Fourier transformation. This transfer function correlates the excitation signal which is transmitted from the generator 28 to the analysis device 30 and/or the measurement signal of the vibration sensors 27, and the measurement signal that is delivered from the vibration sensor 34 to the analysis device 30. The transfer function, which is particularly calculated using fast Fourier transformation (FFT), contains information on the natural frequency spectrum of the bearing system 15.

In the embodiment illustrated in FIG. 1, the piezo vibrator 22 is positioned on the base 18. With respect to the force of gravity, the vibration sensor 34 is seated above the shaft 12 which, with the electric motor 15 as the test object, is positioned between transmission element 24 and transmission element 36.

A clamping device 40 to clamp the bearing system 15 is provided. This device 40 includes an element 42 that acts on the vibration sensor 34 in order to hold it in a defined manner with respect to the shaft 12. Between the vibration sensor 34 and the element 42, a damping element 44 is preferably provided that decouples the device 40 from the shaft 12 in respect of vibration. This damping element 44 can, for example, be made of rubber.

The device 40 preferably comprises one or more weight elements 46, their weight acting on the element 42 so that the bearing system 15 is clamped between the piezo vibrator 22 and the vibration sensor 34 without significantly influencing the vibration being coupled into the shaft 12 and the decoupling of the vibration from the shaft 12.

Either a weight element can be provided that is itself variable with respect to its mass or a set of weight elements can be provided allowing a clamping process to be adjusted in a defined manner.

According to the invention, the vibrational excitation of the shaft 12 of the bearing system 15 as a measurement object is applied via a first end, and particularly an end face 26, and the vibration measurement signal is picked up at the other, second end 32. This ensures that the resonance characteristics of the measured object is not significantly changed by coupling and decoupling. Potential parameters that can result from diverse coupling and excitation are thus essentially reduced. The device and method according to the invention allow the natural frequencies of the bearing system 15 to be determined with high precision and reproducibility.

The bearing system 15 is excited at different frequencies within a frequency band. For example, a sinus sweep is performed in which a sinus vibration frequency is modulated. For a fixed amplitude and a fundamental frequency of 100 Hz, for example, a frequency of up to 8 kHz is run through and then a return is made to the fundamental frequency.

It is also possible for a periodic random noise method to be used in which excitation at a large number of frequencies takes place within the bandwidth. High precision can be achieved in this way.

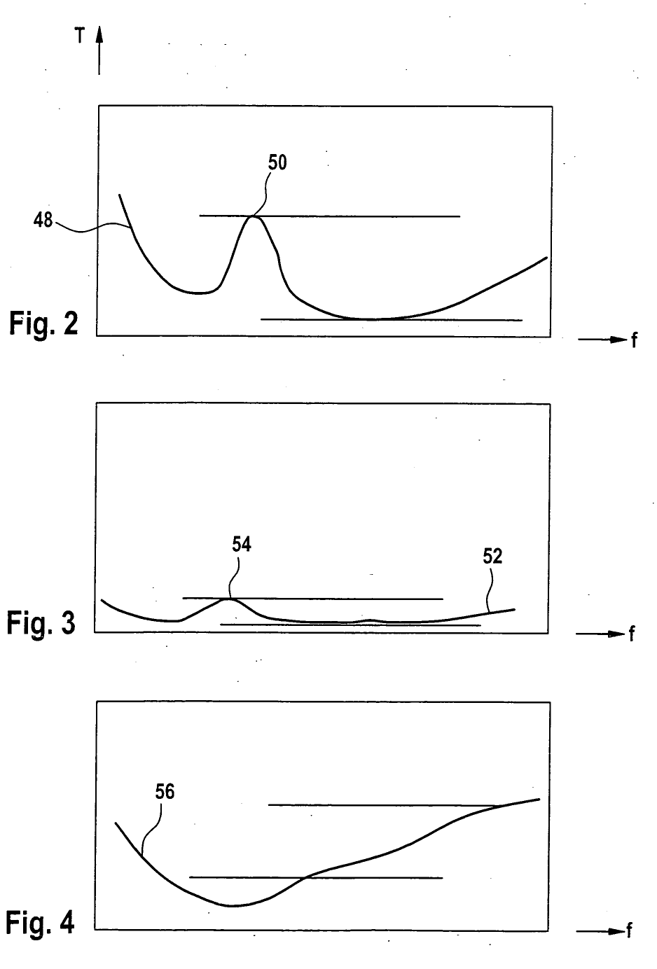

Transfer functions that have been ascertained by the method according to the invention are shown in FIGS. 2 to 4 as a function of their frequencies:

FIG. 2 shows a transfer function 48 that has been ascertained for a roller bearing electric motor having an internal bias (initial) tension of 12 N. In this case the electric motor in its entirety represents the bearing system. A frequency peak 50 can be identified which is attributed to a natural oscillation of the system.

FIG. 3 shows a transfer function 52 for the same bearing system with the initial tension now being 5 N. A peak 54 can be identified which has been shifted to lower frequencies compared to the peak 50 shown in FIG. 2. In addition, the height of the peak is considerably smaller than that of peak 50.

Finally, FIG. 4 shows a transfer function 56 which has been ascertained for the same bearing system (electric motor having a roller bearing) in which the initial tension is less than 2 N. It can be seen that there is no peak within the frequency range illustrated, which means that here there are no natural frequencies.

In comparing FIGS. 2 to 4 it can be seen that the internal initial tension generated by the installation of the shaft 12 (and which can be generated in a defined manner) has a strong effect on the natural frequency spectrum of the electric motor.

This in turn makes it possible to ascertain indirect initial tensions in the bearing system by means of the measured transfer function since the transfer function depends on the initial tensions as shown in FIGS. 2 to 4. The method according to the invention makes it possible to ascertain the frozen-in initial tension in a roller bearing system for the first time in a non-destructive and reproducible manner.

### Identification Reference List

10 Device
12 Shaft
14 Bearing
15 Electric motor/Bearing system
16 Ball elements
18 Base
20 Vibrational excitation device
22 Piezo vibrator
24 Transmission element
26 End face
27 Vibration sensor
28 Generator
30 Analysis device
32 End face
34 Vibration sensor
36 Transmission element
38 Axial direction
40 Clamping device
42 Element
44 Damping element
46 Weight element
48 Transfer function
50 Frequency peak
52 Transfer function
54 Peak
56 Transfer function

1. A method to determine the natural frequencies of a bearing system having a shaft arranged on bearings, comprising:
vibrationally exciting the shaft from one end of the shaft; and
picking up a measurement signal at the other end of the shaft via a vibration sensor.

2. A method according to claim 1, wherein the shaft is excited via an end face.

3. A method according to claim 1, wherein the measurement signal is picked up at an end face.

4. A method according to claim 1, wherein an excitation signal and a resulting measurement signal are correlated.

5. A method according to claim 4, wherein the transfer function is determined with respect to the excitation signal and the measurement signal.

6. A method according to claim 4, wherein a harmonic analysis is performed.

7. A method according to claim 1, wherein the shaft is excited using a piezo vibrator.

8. A method according to claim 1, wherein the measurement signal is picked up via a piezo sensor.

9. A method according to claim 1, wherein a vibrational excitation signal which is coupled into the shaft is determined using another vibration sensor.

10. A device to determine the natural frequencies of the bearing system having a shaft arranged on bearings, comprising:
a vibrational excitation device to vibrationally excite the shaft from one end of the shaft; and
a vibration sensor to pick up a vibration measurement signal at the other end of the shaft.

11. A device according to claim 10, wherein the shaft is positionable between the vibrational excitation device and the vibration sensor.

12. A device according to claim 10, wherein the vibrational excitation device is adapted to be coupled to one end of the shaft.

13. A device according to claim 12, wherein the vibration sensor is adapted to be coupled to the opposite end of the shaft.

14. A device according to claim 10, wherein the vibration sensor is a piezo sensor.

15. A device according to claim 10, wherein the vibrational excitation device comprises a piezo vibrator.

16. A device according to claim 10, wherein an analysis device is provided by means of which an excitation signal of the vibrational excitation device and a measurement signal of the vibration sensor are adapted to be correlated.

17. A device according to claim 16, wherein a transfer function with respect to the excitation signal and the measurement signal is determinable by means of the analysis device.

18. A device according to claim 10, wherein a further vibration sensor is arranged between the vibrational excitation device and the shaft.
